(19) United States
(12) Patent Application Publication
(10) Pub. No.: US 2016/0180623 A1
(43) Pub. Date: Jun. 23, 2016

(54) ELECTRONIC SYSTEMS FOR PROVIDING AND DISTRIBUTING PRODUCTS AND METHODS OF USING THEREOF

(71) Applicant: Filuet Cyprus Ltd., Limassol (CY)

(72) Inventors: Alex Rashkovan, Tel-Aviv, IL (US); Yury Mikhaylov, Moscow (RU)

(21) Appl. No.: 14/978,080

(22) Filed: Dec. 22, 2015

Related U.S. Application Data
(60) Provisional application No. 62/095,201, filed on Dec. 22, 2014.

(51) Int. Cl. G07C 9/00; G06Q 20/18

(52) U.S. Cl. CPC G07C 9/00896; G06Q 20/18; G07C 9/00563; G07C 2009/00936

(57) ABSTRACT

In some embodiments, the present invention provides for a cabinet, including: at least one dispensing unit which includes at least one locker case, a locker controller, a management module which is configured to: i) verify a first user based on at least one security measure, where the at least one security measure includes: (1) a password input, (2) a fingerprint input, (3) an optical input of at least one physical characteristic of the first user, (4) an electronic notification related to the first user, (5) or any combination thereof; ii) generate at least one second computer instruction, and where the at least one second computer instruction is at least one of: (i) designating a delivery address, (ii) obtaining a status of the at least one cell, (iii) instructing the locker controller to open or close the at least one cell, (iv) generating delivery information, and (v) any combination thereof.

### RELATED APPLICATIONS

This application claims the priority of U.S. provisional application U.S. Patent Appln. No. 62/095,201; filed Dec. 22, 2014; entitled “ELECTRONIC SYSTEMS FOR PROVIDING AND DISTRIBUTING PRODUCTS AND METHODS OF USING THEREOF,” which is incorporated herein by reference in its entirety for all purposes.

### TECHNICAL FIELD

In some embodiments, the instant invention is related to a specialized locker and methods/systems to store and distribute products from a specialized locker.

### BACKGROUND

Vending machines dispense items such as snacks, beverages, alcohol, newspapers, and lottery tickets, to customers automatically, after the customer inserts currency or credit into the machine. After the customer inserts currency into the machine, the machine releases the customer selected merchandise, so that it falls in an open compartment at the bottom or into a cup, by unlocking a door, drawer, or turning a knob.

### SUMMARY OF INVENTION

In some embodiments, the present invention provides for a cabinet, including: at least one dispensing unit which includes at least one locker case, where the at least one locker case includes a plurality of cells, where each cell of the plurality of cells is configured to: (i) receive at least one item from a first user, (ii) store the at least one item, and (iii) deliver the at least one item to a second user; a locker controller configured to control a plurality of operations performed by the cabinet, including: (i) send at least one first computer instruction to the at least one locker case, and (ii) receive at least one first electronic response in reply to the at least one first computer instruction from the at least one locker case, and where the at least one first computer instruction is configured to open or close at least one cell of the plurality of cells; a management module which is configured to: i) verify a first user based on at least one security measure related to the first user, where the at least one security measure includes: (1) a password input, (2) a fingerprint input, (3) an optical input of at least one physical characteristic of the first user, (4) an electronic notification related to the first user, (5) or any combination thereof; ii) generate at least one second computer instruction related to at least one delivery of the at least one item to the second user, where the at least one delivery is set by the first user, and where the at least one second computer instruction is at least one of: (i) designating a delivery address for the at least one delivery of the at least one item, where the delivery address is a physical location of the cabinet, (ii) obtaining a status of the at least one cell of the plurality of cells, (iii) instructing the locker controller to open or close the at least one cell, (iv) generating delivery information regarding the at least one delivery, where the delivery information including the delivery address and an identification for the at least one cell within the cabinet, and (v) any combination thereof. In some embodiments, the cabinet includes between 1-20 locker cases. In some embodiments, the plurality of cells is between 10-50 cells. In some embodiments, the management module is further configured to electronically interact with a graphical user interface which is programmed to allow the first user to set the at least one delivery. In some embodiments, the graphical user interface is associated with the cabinet. In some embodiments, the graphical user interface is associated with a mobile device of the first user. In some embodiments, the graphical user interface is configured to permit the at least one first user to remotely access the cabinet. In some embodiments, the management module is further configured to accept a payment for the at least one item from the second user prior to instructing the locker controller to open the at least one cell opening to deliver the at least one item to the second user. In some embodiments, the management module is further configured to accept a payment from the first user for delivering the at least one item. In some embodiments, the electronic notification related to the first user can further include information regarding a time of the at least one delivery, a price of the at least one item, the availability of the at least one item, or any combination thereof. In some embodiments, the at least one second computer instruction for instructing the locker controller to open or close the at least one cell is transmitted utilizing binary code.

In some embodiments, the present invention provides for a method, including: verifying, by a specifically programmed computer processor, a first user based on at least one security measure related to the first user, including: (1) a password input, (2) a fingerprint input, (3) an optical input of at least one physical characteristic of the first user, (4) an electronic notification related to the first user, (5) or any combination thereof; receiving, by the specifically programmed computer processor, a first part of delivery information of at least one item from the first user, including at least a plurality of:1) a description of the at least one item, 2) a delivery address for at least one delivery of the at least one item, where the delivery address is a physical location of a cabinet, 3) a delivery time for the at least one delivery of the at least one item, 4) at least one cost associated with the at least one item, and 5) any combination thereof; where the cabinet includes:at least one dispensing unit which includes at least one locker case, where the at least one locker case includes a plurality of cells, where each cell of the plurality of cells is configured to: (i) receive the at least one item from a first user, (ii) store the at least one item, and (iii) deliver the at least one item to a second user; a locker controller configured to control a plurality of operations performed by the cabinet, including:(i) send at least one first computer instruction to the at least one locker case, and (ii) receive at least one first electronic response in reply to the at least one first computer instruction from the at least one locker case, and where the at least one first computer instruction is configured to open or close at least one cell of the plurality of cells; allowing, by the specifically programmed computer processor, the first user to deposit the at least one item in at least one cell of a plurality of cells in the cabinet, generating, by the specifically programmed computer processor, a second part of delivery information related to the at least one item to the first user, where the second part of delivery information including: 1) a time when the at least one item has been delivered to a second user, 2) a payment of the at least one item by the second user, 3) a completed delivery of the at least one item to the second user, and 4) any combination thereof. In some embodiments, the delivery information is transmitted to the second user. In some embodiments, the second user can pay for the at least one item at the time of the at least one delivery. In some embodiments, the first user can pay for the at least one item prior to the at least one delivery. In some embodiments, the cabinet includes between 1-20 locker cases. In some embodiments, the plurality of cells is between 10-50 cells. In some embodiments, the electronic notification related to the first user can further include information regarding a time of the at least one delivery, a price of the at least one item, the availability of the at least one item, or any combination thereof.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

FIG. 1 illustrates some embodiments of the system of the present invention, showing network servers communicating with client devices by use of a network.

FIG. 2 illustrates some embodiments of the system of the present invention, showing a computer and network architecture that supports the inventive system.

FIG. 3 illustrates some embodiments of the system of the present invention, showing a cloud system supporting the inventive system.

FIG. 4 illustrates some embodiments of the system of the present invention, showing the cloud systems supporting the inventive system and allowing a delivering and receiving of information to and/or from cloud clients.

FIG. 5 illustrates an embodiment of the cabinet of the present invention, showing how the cabinet can be placed in an environment.

FIGS. 6-9 illustrate embodiments of the method of the present invention, illustrating a flow chart providing a service to a user.

FIG. 10 illustrates an embodiment of a lock design of the cabinet of the present invention.

FIG. 11 illustrates an embodiment of a locker controller of the cabinet of the present invention.

FIG. 12 illustrates an embodiment of a cell structure of the cabinet of the present invention.

FIGS. 13, 14A-14C, 15, and 16A-16C illustrate embodiments of the cabinet of the present invention.

In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

### DESCRIPTION OF EXEMPLARY EMBODIMENTS

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

In some embodiments, the system(s) of the present invention is/are configured to allow at least one user to perform at least one of the following:
buy products available in at least one dispensing cabinet(s) (i.e., “on spot”);
receive (i.e., “pick up”) at least one item (e.g., a parcel), where the at least one item can include at least one product purchased and/or at least one product previously paid for (e.g., but not limited to, payment was received by the system “on-line”);
pay for at least one product (e.g., but not limited to on-line order) at a first time point and receive at least one item from the at least one locker cabinet(s) at a second time point;
provide “pay on delivery” of the at least one item (e.g., the system(s) is/are configured to offer the at least one user to obtain/“pick up” an item with good(s) having been ordered before (e.g., but not limited to, online) via integrated e-commerce web site at a first time point and complete a payment at an automated store (i.e., an “Auto-Store”) “on spot” at a second time point by use of the system(s); escrow (i.e., money/goods deposited and stored in the system(s) on behalf of the at least one user);
return/send at least one item(s) and/or product(t)s to at least one seller;
or any combination thereof.

In some embodiments, the system(s) of the present invention is/are configured to provide a graphical user interface (GUI) to a user to perform activities in accordance with principles of the instant invention through an “Application Program Interface(s)” (API(s)) (exemplified here as “ASCo POS system/software”, but is not limited to the examples presented and other GUIs are contemplated), which is/are the software routines configured to execute user commands. In some embodiments, the API(s) is programmed to communicate directly and/or indirectly with a Dispensing Cabinet or a Locker Controller, where a Locker Controller is a device programmed to provide commands to the Locker Cabinet containing cells with locks (e.g., open cell 8 of the Locker cabinet once the user has tendered payment for the contents of cell 8). In some embodiments, the system(s) of the present invention is/are configured to use a Locker Controller to manage every cell within at least one Locker cabinet, where the Locker Controller is configured to manage each cell by sending open and close commands once received from the software of the present invention.

In some embodiments, the system(s) of the present invention include(s) a management tower and/or at least one dispensing unit, and/or at least one locker case. In some embodiments, the at least one locker case (e.g., 1, 2, 3, 4, 5, etc.) includes a plurality of cells. In some embodiments, each cell is configured to hold and give access to at least one item to a user. In some embodiments, the at least one locker case is configured to receive commands from a locker controller device. In some embodiments, the controller device is configured to manage each cell of the locker case (i.e., sending commands and receiving responses).

In some embodiments of the systems of the present invention, the system(s) include between 1-20 locker cases. In some embodiments, the system(s) include between 1-15 locker cases. In some embodiments, the system(s) include between 1-10 locker cases. In some embodiments, the system(s) include between 1-5 locker cases. In some embodiments, the system(s) include between 5-20 locker cases. In some embodiments, the system(s) include between 10-20 locker cases. In some embodiments, the system(s) include between 15-20 locker cases.

In some embodiments of the system(s) of the present invention, the system(s) include at least one locker case, where the at least one locker case includes between 1-50 cells. In some embodiments, the at least one locker case includes between 1-40 cells. In some embodiments, the at least one locker case includes between 1-30 cells. In some embodiments, the at least one locker case includes between 1-20 cells. In some embodiments, the at least one locker case includes between 1-10 cells. In some embodiments, the at least one locker case includes between 10-50 cells. In some embodiments, the at least one locker case includes between 20-50 cells. In some embodiments, the at least one locker case includes between 30-50 cells. In some embodiments, the at least one locker case includes between 40-50 cells. In some embodiments, the at least one locker case includes between 10-40 cells. In some embodiments, the at least one locker case includes between 10-30 cells. In some embodiments, the at least one locker case includes between 10-20 cells.

In some embodiments, the system(s) of the present invention include(s) at least one dispensing unit configured to dispense at least one product. In some embodiments, the at least one dispensing unit is configured to dispense a plurality of products.

In some embodiments, the system(s) of the present invention is/are configured to support a plurality of commands, where the plurality of commands can reside at a fixed or mobile location, e.g., at the location of the locker case and/or on a mobile electronic device, and the plurality of commands is configured to control the operation of the dispensing cabinet(s) and/or each product location. In some embodiments, the each of the plurality of commands is configured to provide at least one following action to a user including, but not limited to:
provide a status of at least one dispensing cabinet and/or product location (e.g., whether a location is empty or not);
set a dispensing cabinet and/or product location system parameters (e.g. time before moving to standby mode);
dispense product(s); or
any combination thereof.
   In some embodiments, the system(s) of the present invention are configured to include an API(s) that can be controlled at a fixed location and/or a mobile location, as non-limiting examples, the location of the Locker Cabinet and/or at a remote location. In some embodiments, a computer application and/or a website is configured to allow a user can gain remote access to the present system. In some embodiments, the computer application can be designed to be compatible with a touch screen and/or a mobile keyboard (e.g., but not limited to, a keyboard of a mobile phone, tablet, portable computer, etc.). In some embodiments, the computer application includes at least one security measure, where the at least one security measure can substantially increase a security level, and can include, as non-limiting examples, password protection, fingerprint detection, optical detection, notifications, or any combination thereof. In some embodiments, a notification can include information describing at least one item selected by a user (e.g., number of items ordered, price, availability, etc.). In some embodiments, the notification can include information regarding pick-up time and/or location of the at least one item. In some embodiments, the at least one security measure can be used to unlock the inventive system at the location of the item and/or at a remote location. In some embodiments, the system can include an encryption, such as, but not limited to, MD5 encryption protocol, to protect remote and/or local communications from being fraudulently exposed.

In some embodiments, the system(s) of the present invention is/are configured to support a plurality of commands, where the plurality of commands controls the operation of the locker cabinet(s) and/or each cell. In some embodiments of the system, the each of the plurality of commands is configured to provide at least one following action to a user including, but not limited to:
change an address of at least one locker cabinet/unit,
provide a status of at least one cell (e.g., whether a cell is occupied or vacant),
receive an input regarding a quantity(ies) of a cell(s) available for use,
open and/or close at least one cell, or
any combination thereof.

In some embodiments of the system(s) of the present invention, software is configured to manage each cell status, each address, each case, etc., by use of each command(s) provided by the Locker Controller.

In some embodiments, the system(s) of the present invention use at least two commands/inputs sent by the software which is/are configured to provide the following functions: (1) close the cell and (2) open the cell. In some embodiments, the commands for functions comprising (1) close the cell and (2) open the cell are as follows:

0×A5 <CELL ADDRESS> 0×03 0×01 0 CRC Close the cell

0×A5 <CELL ADDRESS> 0×03 0×01 1 CRC Open the cell

In some embodiments, the system(s) of the present invention are configured to send instructions to a kiosk with inventive lockers from a server. In some embodiments, the kiosk can be placed in a public venue, e.g., a mall, a retail store, a university, a corporate entity, or any combination thereof.

In some embodiments, the system(s) of the present invention is/are configured to offer a user a plurality of functionalities including, but not limited to buying, obtaining, sending, placing in escrow, or any combination thereof. In some embodiments, the system(s) is/are configured to perform a plurality of actions for a user during each transaction (e.g., but not limited to, accepting an item, receiving payment (e.g., swiping a credit card/debit card/cash), providing confirmation to a user, storing an item/locking a cell).

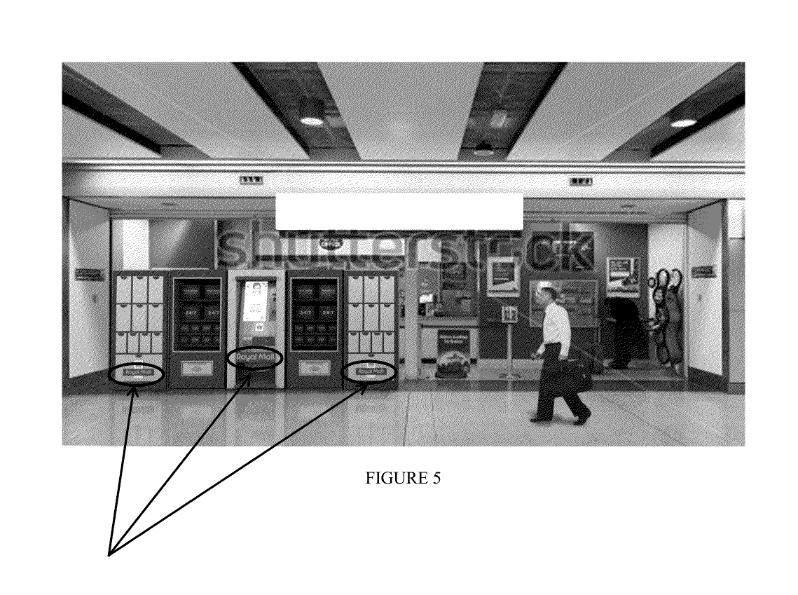

FIG. 5 is an embodiment of the system(s) of the present invention, illustrating a system(s) provided to a possible user.

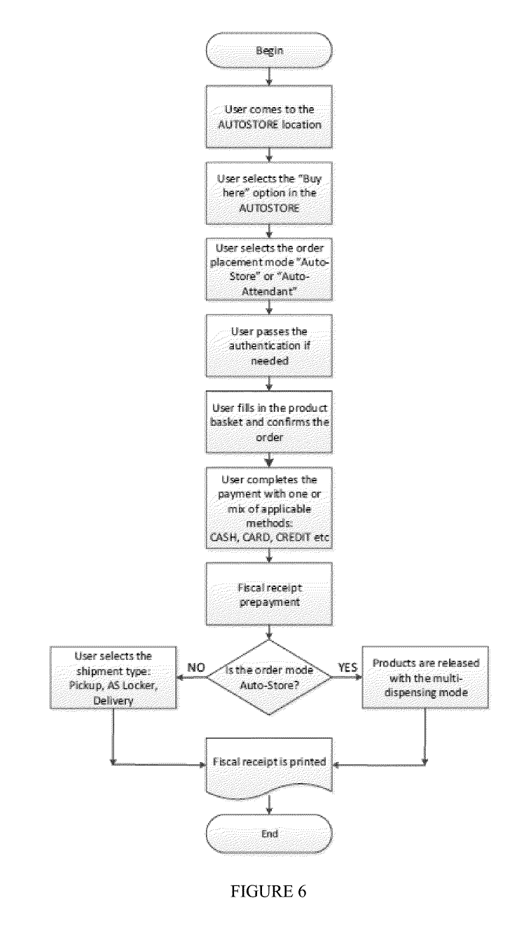

FIG. 6 is an embodiment of the system(s) of the present invention, illustrating a flow chart providing a service to a user (e.g., “Buy here”). In some embodiments, the system can be configured to release the product(s) at the time of purchase (i.e., “on spot”) and/or via pickup, dispensing cabinet, locker cabinet, delivery shipment, or any combination thereof. In some embodiments, multiple purchases (i.e., product(s)) can be released to a user through two or more types of release (e.g., by dispensing cabinet, locker cabinet and delivery shipment).

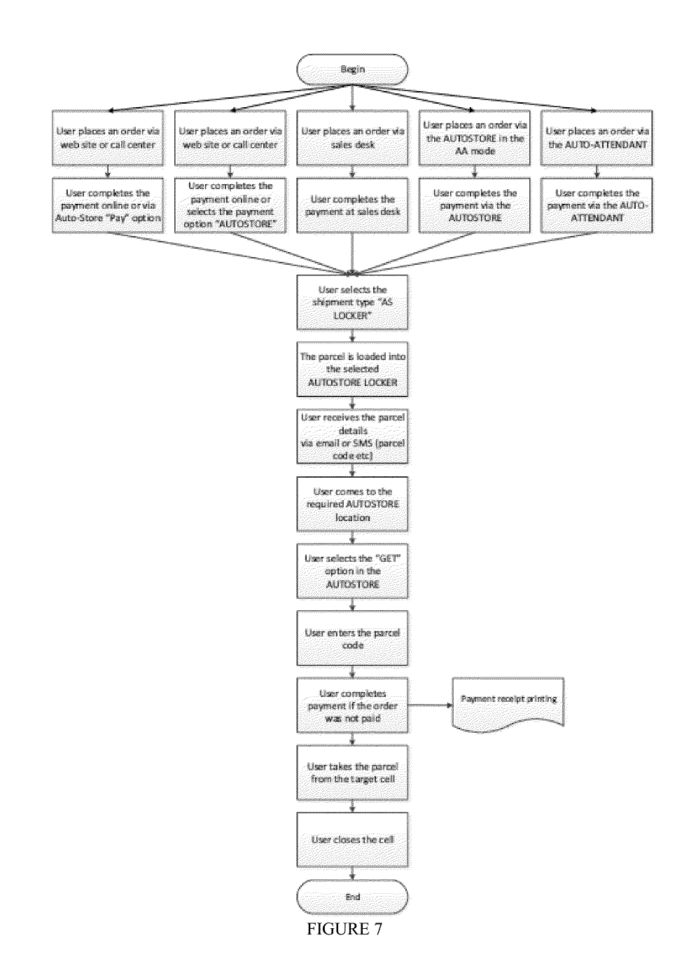

FIG. 7 is an embodiment of the system of the present invention, illustrating a flow chart providing a service to a user (e.g., “Receive item”). In some embodiments, the exemplary flow chart illustrates the system being configured to allow several options to a user: to pick up an item with goods purchased online, via call center, sales desk or Auto-Store; pay for online, call center order during pickup with any applicable method; cash on delivery; or any combination thereof.

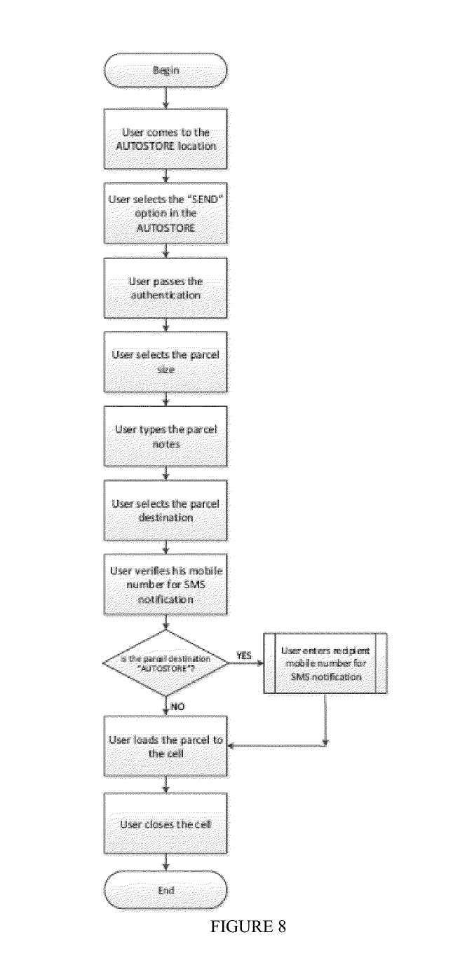

FIG. 8 is an embodiment of the system of the present invention, illustrating a flow chart providing a service to a user (e.g., “Send parcel” or “Send item”). In some embodiments, the system(s) of the present invention is/are configured to allow a user to perform the following operations: send an item(s)/product(s)/document(s) back to a seller, exchange item(s), products between registered users, escrow, or any combination thereof.

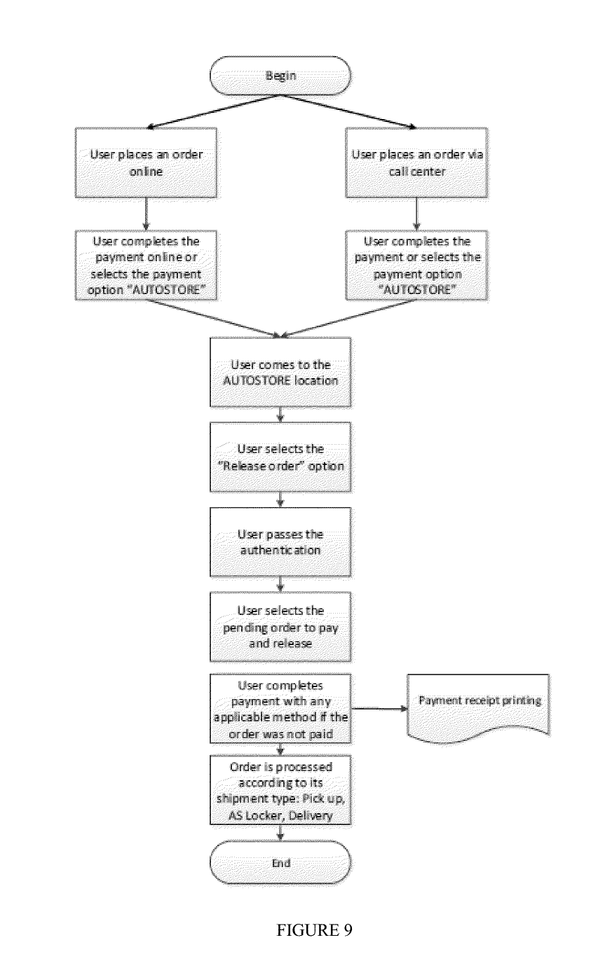

FIG. 9 is an embodiment of the system of the present invention, illustrating a flow chart providing a service to a user (e.g., “Release order”). In some embodiments, the system(s) of the present invention is/are configured to allow a user to pay for at least one order placed online and/or by call center by: paying for online and/or call center order and/or collect from the dispensing cabinet the, e.g., following day; paying for online and/or call center order and/or receiving at least one good(s)on the spot from the pickup window; paying for online and/or call center order and/or release for at least one delivery, or any combination thereof.

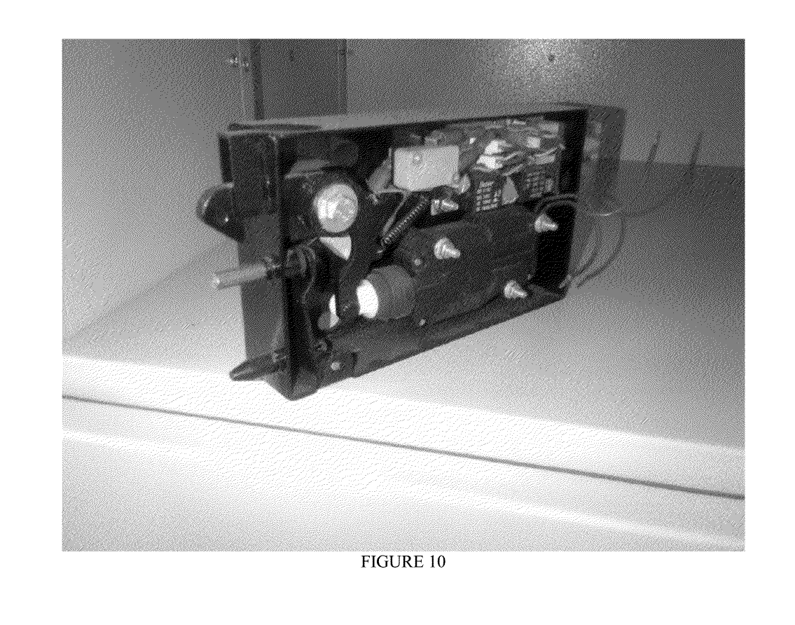

FIG. 10 is an embodiment of the system of the present invention, illustrating a lock design. In some embodiments, the system(s) of the present invention(s) is/are configured to use a lock mechanism to automatically control a cell in an open or closed state. In some embodiments, the system(s) of the present invention can be configured to close a cell automatically after at least one item is released (e.g., the system does not receive an input from a user to close the cell, recognizes an elapsed period of time (e.g., 5 seconds, 10 seconds, 20 seconds, 30 seconds, 60 seconds, etc.) since providing the item to the user and/or received an input from a new user, and is configured to automatically close the cell).

FIG. 11 is an embodiment of the system of the present invention, illustrating a Locker Controller.

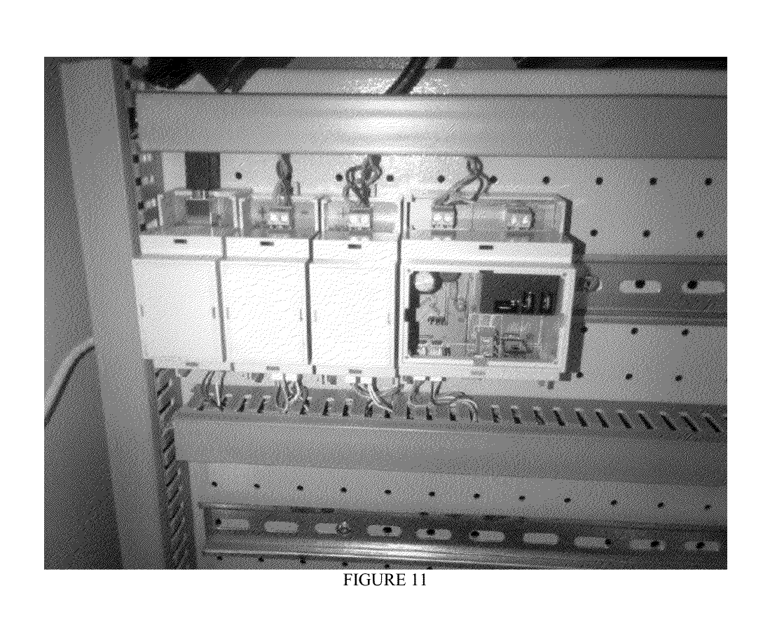

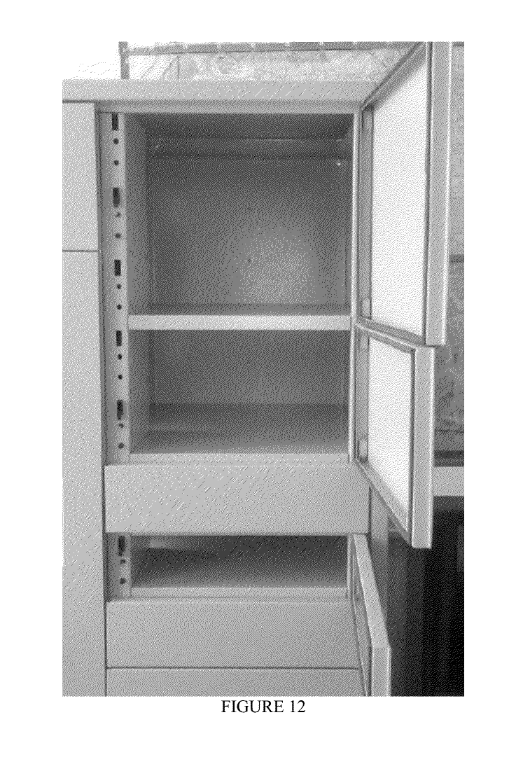

FIG. 12 is an embodiment of the system of the present invention, illustrating a cell structure. In some embodiments, the system(s) of the present invention is/are configured to allow a user to deposit items, goods, boxes, documents (e.g., envelopes, papers, books, etc.), or any combination thereof and provide support for providing and depositing items (i.e., item exchange).

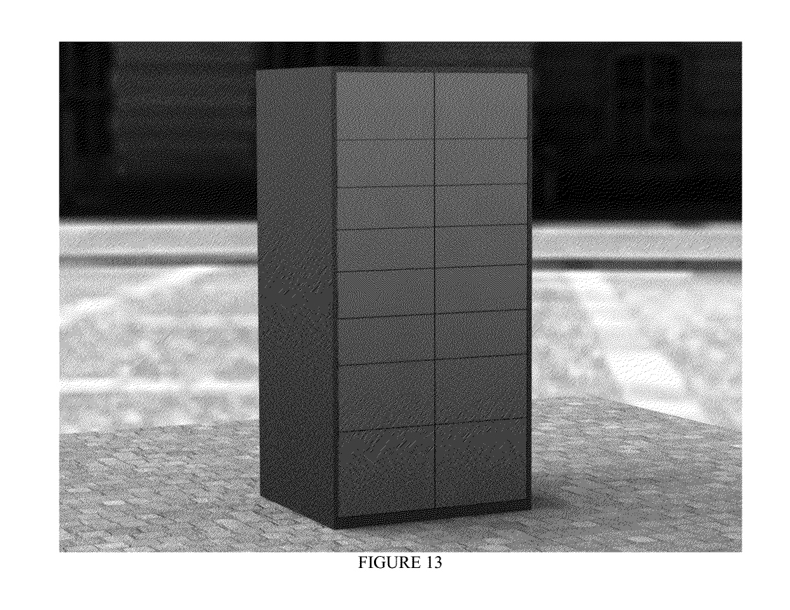

FIG. 13 is an embodiment of the system of the present invention, illustrating, in three dimensions, a dispensing cabinet with horizontal cells.

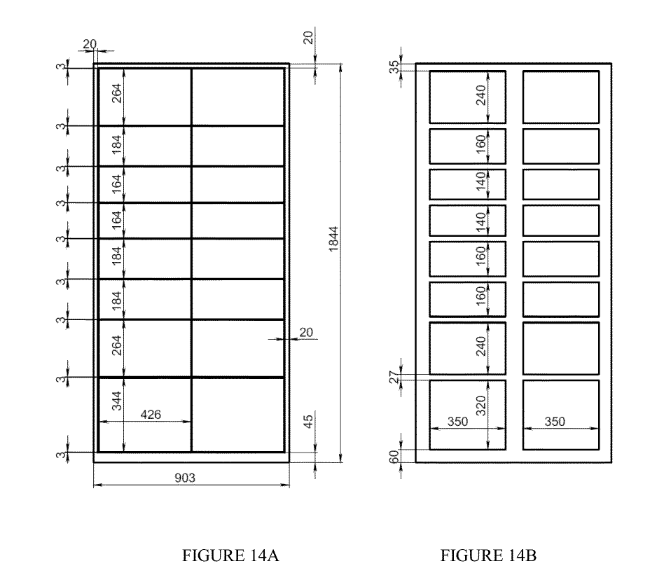

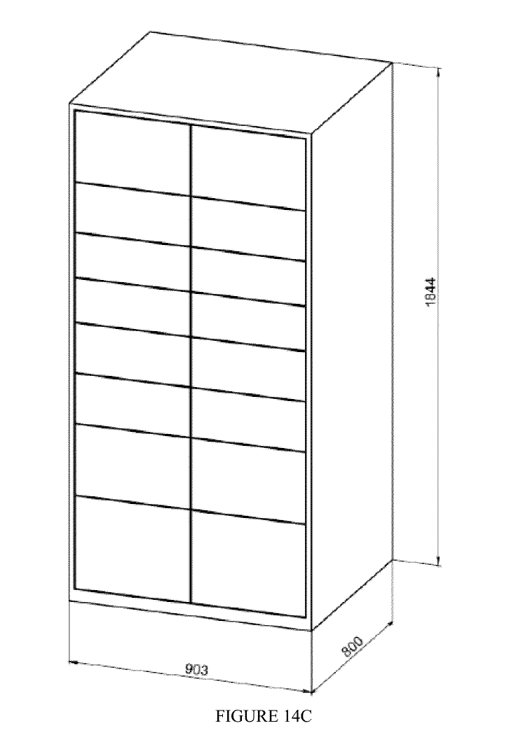

FIGS. 14A-14C are embodiments of the system of the present invention, illustrating a lock with horizontal cells. FIG. 14A is a front view of the cabinet with doors attached. FIG. 14B is a front view of the cabinet without the doors attached. FIG. 14C is a second view of the cabinet with doors attached.

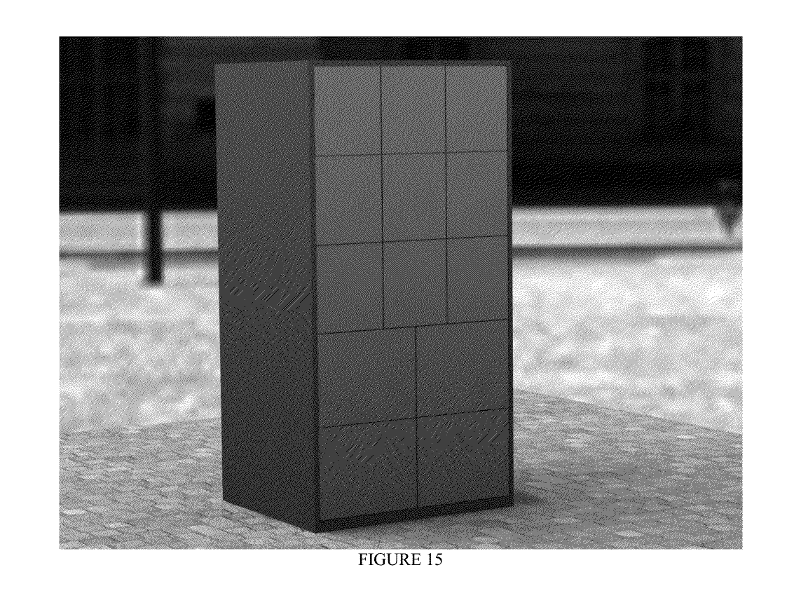

FIG. 15 is an embodiment of the system of the present invention, in three dimensions, illustrating a lock with vertical cells.

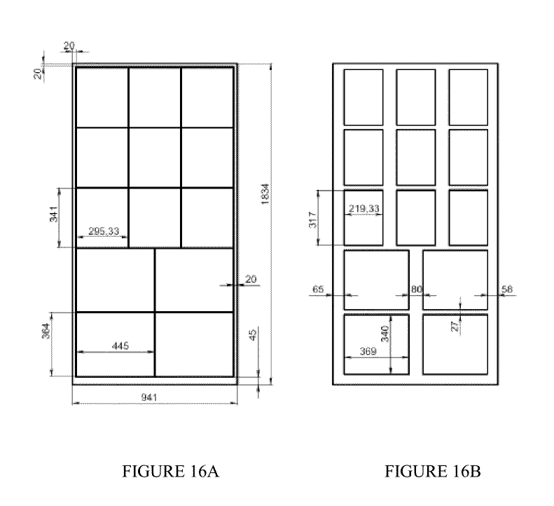

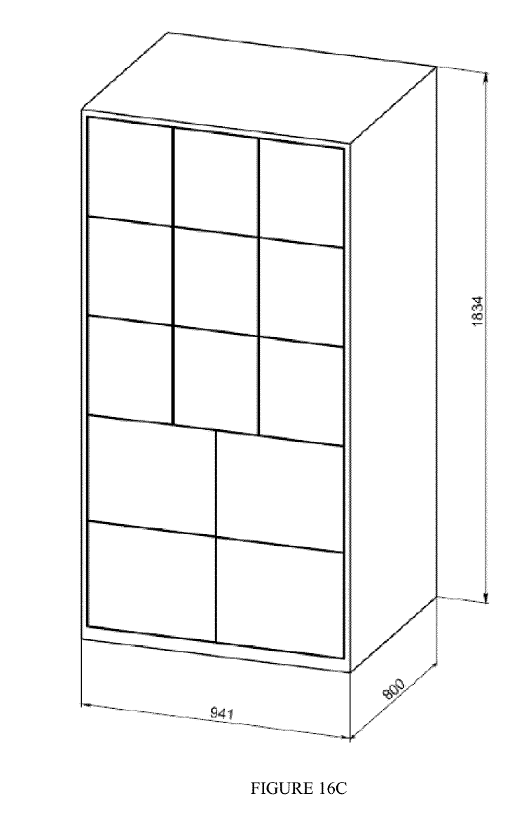

FIG. 16A-16C are embodiments of the system of the present invention, illustrating a lock with vertical cells. FIG. 16A shows the front view of the cabinet with doors attached. FIG. 16B shows the front view of the cabinet without doors attached. FIG. 16C shows a second view of the front view of the cabinet with doors attached.

In some embodiments, the present invention provides for a cabinet, including: at least one dispensing unit which includes at least one locker case, where the at least one locker case includes a plurality of cells, where each cell of the plurality of cells is configured to: (i) receive at least one item from a first user, (ii) store the at least one item, and (iii) deliver the at least one item to a second user; a locker controller configured to control a plurality of operations performed by the cabinet, including: (i) send at least one first computer instruction to the at least one locker case, and (ii) receive at least one first electronic response in reply to the at least one first computer instruction from the at least one locker case, and where the at least one first computer instruction is configured to open or close at least one cell of the plurality of cells; a management module which is configured to: i) verify a first user based on at least one security measure related to the first user, where the at least one security measure includes: (1) a password input, (2) a fingerprint input, (3) an optical input of at least one physical characteristic of the first user, (4) an electronic notification related to the first user, (5) or any combination thereof; ii) generate at least one second computer instruction related to at least one delivery of the at least one item to the second user, where the at least one delivery is set by the first user, and where the at least one second computer instruction is at least one of: (i) designating a delivery address for the at least one delivery of the at least one item, where the delivery address is a physical location of the cabinet, (ii) obtaining a status of the at least one cell of the plurality of cells, (iii) instructing the locker controller to open or close the at least one cell, (iv) generating delivery information regarding the at least one delivery, where the delivery information including the delivery address and an identification for the at least one cell within the cabinet, and (v) any combination thereof. In some embodiments, the cabinet includes between 1-20 locker cases. In some embodiments, the plurality of cells is between 10-50 cells. In some embodiments, the management module is further configured to electronically interact with a graphical user interface which is programmed to allow the first user to set the at least one delivery. In some embodiments, the graphical user interface is associated with the cabinet. In some embodiments, the graphical user interface is associated with a mobile device of the first user. In some embodiments, the graphical user interface is configured to permit the at least one first user to remotely access the cabinet. In some embodiments, the management module is further configured to accept a payment for the at least one item from the second user prior to instructing the locker controller to open the at least one cell opening to deliver the at least one item to the second user. In some embodiments, the management module is further configured to accept a payment from the first user for delivering the at least one item. In some embodiments, the electronic notification related to the first user can further include information regarding a time of the at least one delivery, a price of the at least one item, the availability of the at least one item, or any combination thereof. In some embodiments, the at least one second computer instruction for instructing the locker controller to open or close the at least one cell is transmitted utilizing binary code.

In some embodiments, the present invention provides for a method, including: verifying, by a specifically programmed computer processor, a first user based on at least one security measure related to the first user, including: (1) a password input, (2) a fingerprint input, (3) an optical input of at least one physical characteristic of the first user, (4) an electronic notification related to the first user, (5) or any combination thereof; receiving, by the specifically programmed computer processor, a first part of delivery information of at least one item from the first user, including at least a plurality of:1) a description of the at least one item, 2) a delivery address for at least one delivery of the at least one item, where the delivery address is a physical location of a cabinet, 3) a delivery time for the at least one delivery of the at least one item, 4) at least one cost associated with the at least one item, and 5) any combination thereof; where the cabinet includes: at least one dispensing unit which includes at least one locker case, where the at least one locker case includes a plurality of cells, where each cell of the plurality of cells is configured to: (i) receive the at least one item from a first user, (ii) store the at least one item, and (iii) deliver the at least one item to a second user; a locker controller configured to control a plurality of operations performed by the cabinet, including:(i) send at least one first computer instruction to the at least one locker case, and (ii) receive at least one first electronic response in reply to the at least one first computer instruction from the at least one locker case, and where the at least one first computer instruction is configured to open or close at least one cell of the plurality of cells; allowing, by the specifically programmed computer processor, the first user to deposit the at least one item in at least one cell of a plurality of cells in the cabinet, generating, by the specifically programmed computer processor, a second part of delivery information related to the at least one item to the first user, where the second part of delivery information including: 1) a time when the at least one item has been delivered to a second user, 2) a payment of the at least one item by the second user, 3) a completed delivery of the at least one item to the second user, and 4) any combination thereof. In some embodiments, the delivery information is transmitted to the second user. In some embodiments, the second user can pay for the at least one item at the time of the at least one delivery. In some embodiments, the first user can pay for the at least one item prior to the at least one delivery. In some embodiments, the cabinet includes between 1-20 locker cases. In some embodiments, the plurality of cells is between 10-50 cells. In some embodiments, the electronic notification related to the first user can further include information regarding a time of the at least one delivery, a price of the at least one item, the availability of the at least one item, or any combination thereof.

Illustrative Operating Environments

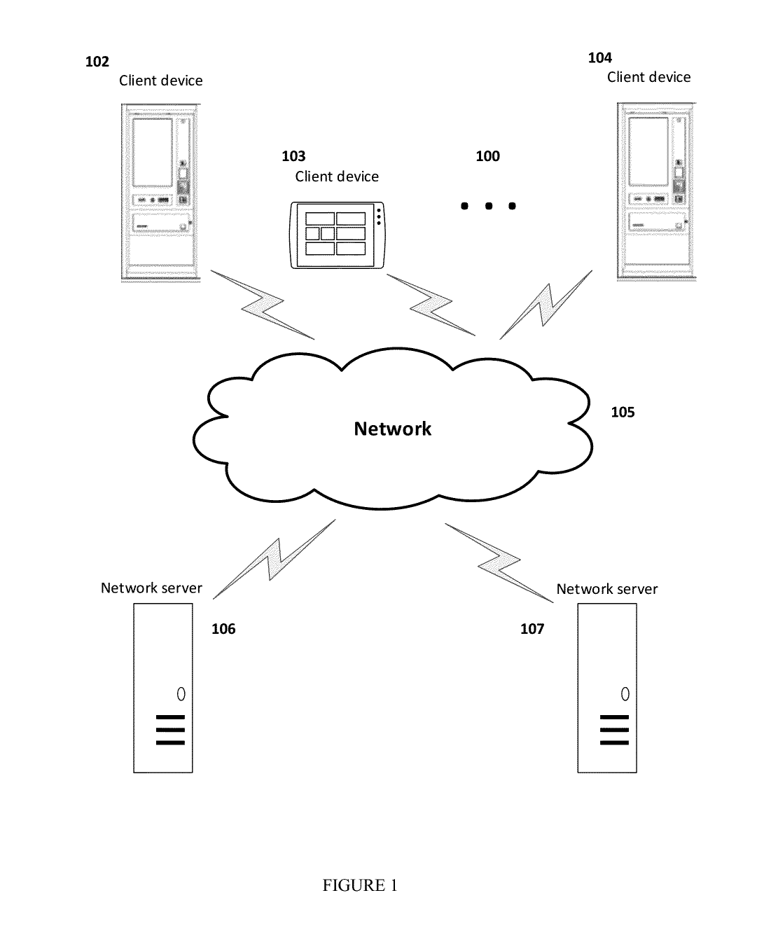

FIG. 1 illustrates one embodiment of an environment in which the present invention may operate. However, not all of these components may be required to practice the invention, and variations in the arrangement and type of the components may be made without departing from the spirit or scope of the invention. In some embodiments, the inventive system and method may include a large number of members and/or concurrent transactions at one or more cabinets. In other embodiments, the inventive system and method are based on a scalable computer and network architecture that incorporates various strategies for assessing the data, caching, searching, and database connection pooling. An example of the scalable architecture is an architecture that is capable of operating multiple servers.

In embodiments, members of the computer system 102-104 include virtually any computing device capable of receiving and sending a message over a network, such as network 105, to and from another computing device, such as servers 106 and 107, each other, and the like. In embodiments, the set of such devices includes devices that typically connect using a wired communications medium such as personal computers, multiprocessor systems, microprocessor-based or programmable consumer electronics, network PCs, and the like. In embodiments, the set of such devices also includes devices that typically connect using a wireless communications medium such as cell phones smart phones, pagers, walkie talkies, radio frequency (RF) devices, infrared (IR) devices, CBs, integrated devices combining one or more of the preceding devices, or virtually any mobile device, and the like. Similarly, in embodiments, client devices 102-104 are any device that is capable of connecting using a wired or wireless communication medium such as a PDA, POCKET PC, wearable computer, and any other device that is equipped to communicate over a wired and/or wireless communication medium.

In embodiments, each member device within member devices 102-104 may include a browser and/or desktop or mobile application that is configured to receive and to send web pages and/or commands, and the like. In embodiments, the browser and/or desktop or mobile application may be configured to receive and display graphics, text, multimedia, and the like, employing virtually any web based or programming language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In embodiments, programming may include either Java, .Net, QT, C, C++, C#, SQL, Transact SQL or other suitable programming language.

In embodiments, member devices 102-104 may be further configured to receive a message from another computing device employing another mechanism, including, but not limited to email, Short Message Service (SMS), Multimedia Message Service (MIMS), instant messaging (IM), internet relay chat (IRC), mIRC, Jabber, and the like or a Proprietary protocol.

In embodiments, network 105 may be configured to couple one computing device to another computing device to enable them to communicate. In some embodiments, network 105 may be enabled to employ any form of computer readable media for communicating information from one electronic device to another. Also, in embodiments, network 105 may include a wireless interface, and/or a wired interface, such as the Internet, in addition to local area networks (LANs), wide area networks (WANs), direct connections, such as through a universal serial bus (USB) port, other forms of computer-readable media, or any combination thereof. In embodiments, on an interconnected set of LANs, including those based on differing architectures and protocols, a router may act as a link between LANs, enabling messages to be sent from one to another.

Also, in some embodiments, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, in some embodiments, remote computers and other related electronic devices could be remotely connected to either LANs or WANs via a modem and temporary telephone link. In essence, in some embodiments, network 105 includes any communication method by which information may travel between client devices 102-104, and servers 106 and 107.

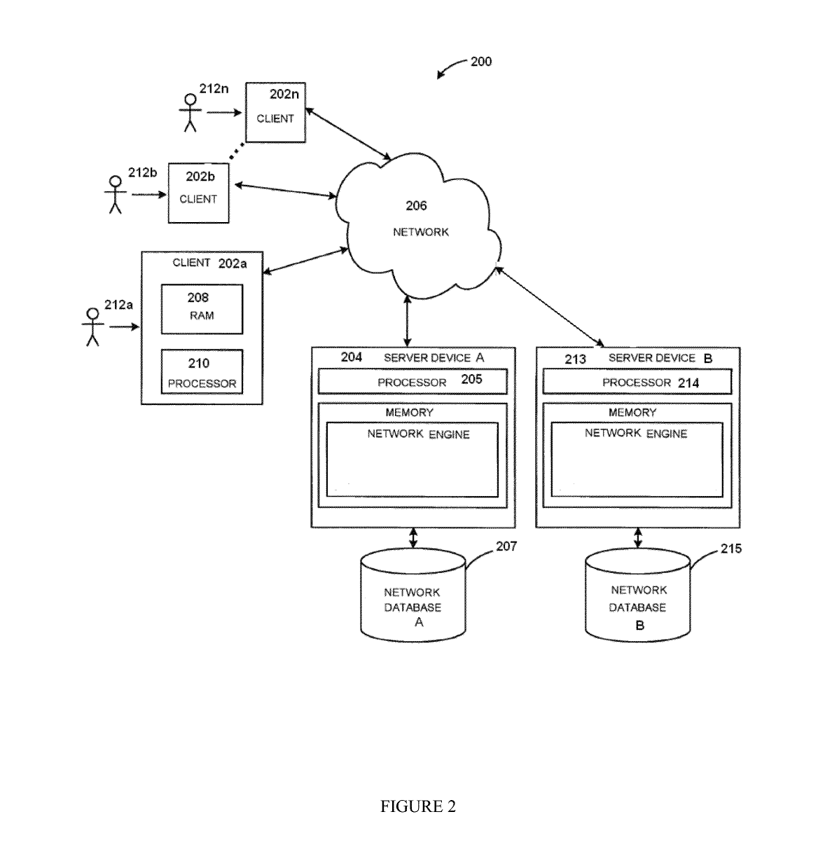

FIG. 2 shows another exemplary embodiment of the computer and network architecture that supports the methods and systems of the instant invention. In some embodiments, the member devices 202a, 202b thru 202n shown each at least includes a computer-readable medium, such as a random access memory (RAM) 208 coupled to a processor 210 or FLASH memory. In some embodiments, the processor 210 may execute computer-executable program instructions stored in memory 208. In some embodiments, such processors comprise a microprocessor, an ASIC, and state machines. In some embodiments, uch processors comprise, or may be in communication with, media, for example computer-readable media, which stores instructions that, when executed by the processor, cause the processor to perform the steps described herein. Embodiments of computer-readable media may include, but are not limited to, an electronic, optical, magnetic, or other storage or transmission device capable of providing a processor, such as the processor 210 of client 202a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, C#, Visual Basic, Java, Python, Perl, and JavaScript.

In some embodiments, member devices 202a-n may also comprise a number of external or internal devices such as a mouse, a CD-ROM, DVD, a keyboard, a display, or other input or output devices. Examples of client devices 202a-n may be personal computers, digital assistants, personal digital assistants, cellular phones, mobile phones, smart phones, pagers, digital tablets, laptop computers, Internet appliances, and other processor-based devices. In general, a client device 202a may be any type of processor-based platform that is connected to a network 206 and that interacts with one or more application programs. Client devices 202a-n may operate on any operating system capable of supporting a browser or browser-enabled application, such as Microsoft™, Windows™, or Linux. The client devices 202a-n shown may include, for example, personal computers executing a browser application program such as Microsoft Corporation's Internet Explorer™, Apple Computer, Inc.'s Safari™, Mozilla Firefox, and Opera. Through the client devices 202a-n, users, 212a-n communicate over the network 206 with each other and with other systems and devices coupled to the network 206. As shown in FIG. 2, server devices 204 and 213 may be also coupled to the network 206. In an embodiment of the present invention, one or more clients can be a mobile client.

In some embodiments, the term “mobile electronic device” may refer to any portable electronic device that may or may not be enabled with location tracking functionality. For example, a mobile electronic device can include, but is not limited to, a mobile phone, Personal Digital Assistant (PDA), Blackberry™, Pager, Smartphone, or any other reasonable mobile electronic device. For ease, at times the above variations are not listed or are only partially listed, this is in no way meant to be a limitation.

In some embodiments, the terms “proximity detection,” “locating,” “location data,” “location information,” and “location tracking” as used herein may refer to any form of location tracking technology or locating method that can be used to provide a location of a mobile electronic device, such as, but not limited to, at least one of location information manually input by a user, such as, but not limited to entering the city, town, municipality, zip code, area code, cross streets, or by any other reasonable entry to determine a geographical area; Global Positions Systems (GPS); GPS accessed using Bluetooth™; GPS accessed using any reasonable form of wireless and/or non-wireless communication; WiFi™ server location data; Bluetooth™ based location data; triangulation such as, but not limited to, network based triangulation, WiFi™ server information based triangulation, BluetoothTM server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed, this is in no way meant to be a limitation.

In some embodiments, near-field wireless communication (NFC) can represent a short-range wireless communications technology in which NFC-enabled devices are “swiped,” “bumped,” “tap” or otherwise moved in close proximity to communicate. In some embodiments, NFC could include a set of short-range wireless technologies, typically requiring a distance of 10 cm or less.

In some embodiments, NFC may operate at 13.56 MHz on ISO/IEC 18000-3 air interface and at rates ranging from 106 kbit/s to 424 kbit/s. In some embodiments, NFC can involve an initiator and a target; the initiator actively generates an RF field that can power a passive target. In some embodiment, this can enable NFC targets to take very simple form factors such as tags, stickers, key fobs, or cards that do not require batteries. In some embodiments, NFC peer-to-peer communication can be conducted when a plurality of NFC-enable devices within close proximity of each other.

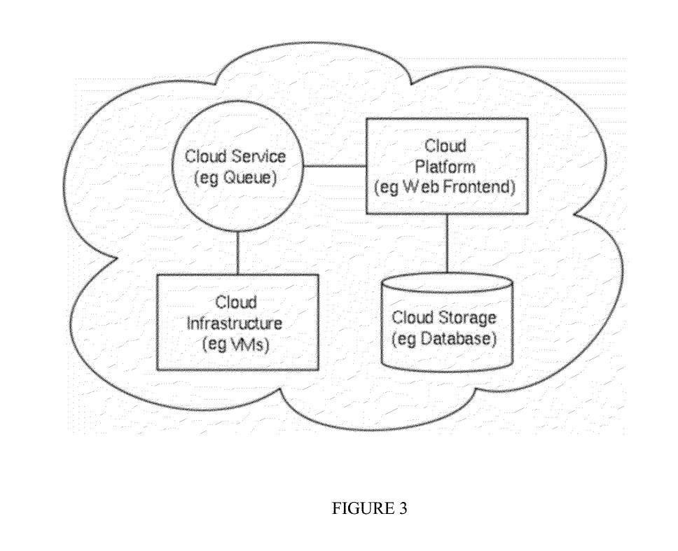

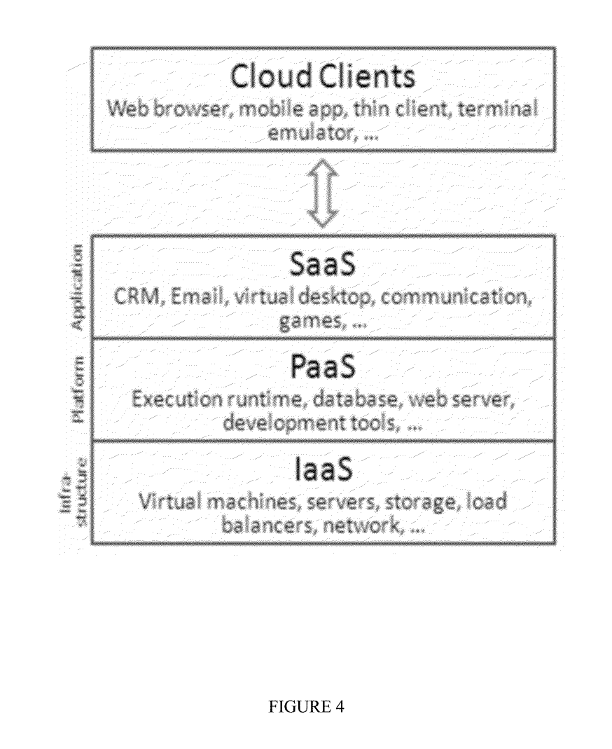

For purposes of the instant description, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user). In some embodiments, the instant invention offers/manages or may use/manage the cloud computing/architecture as, but not limiting to: infrastructure a service (IaaS), platform as a service (PaaS), and software as a service (SaaS). FIGS. 3 and 4 illustrate schematics of exemplary implementations of the cloud computing/architecture.

Of note, the embodiments described herein may, of course, be implemented using any appropriate computer system hardware and/or computer system software. In this regard, those of ordinary skill in the art are well versed in the type of computer hardware that may be used (e.g., a mainframe, a mini-computer, a personal computer (“PC”), a network (e.g., an intranet and/or the internet)), the type of computer programming techniques that may be used (e.g., object oriented programming), and the type of computer programming languages that may be used (e.g., C++, C#. Basic, AJAX, Javascript). The aforementioned examples are, of course, illustrative and not restrictive.

While a number of embodiments of the present invention have been described, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated).

What is claimed is:

1. A cabinet, comprising:
at least one dispensing unit which comprises at least one locker case, wherein the
at least one locker case comprises a plurality of cells,
wherein each cell of the plurality of cells is configured to:
(i) receive at least one item from a first user,
(ii) store the at least one item, and
(iii) deliver the at least one item to a second user;
a locker controller configured to control a plurality of operations performed by the cabinet, comprising:
(i) send at least one first computer instruction to the at least one locker case, and
(ii) receive at least one first electronic response in reply to the at least one first computer instruction from the at least one locker case, and
wherein the at least one first computer instruction is configured to open or close at least one cell of the plurality of cells;
a management module which is configured to:
i) verify a first user based on at least one security measure related to the first user, wherein the at least one security measure comprises:
1) a password input,
2) a fingerprint input,
3) an optical input of at least one physical characteristic of the first user,
4) an electronic notification related to the first user,
5) or any combination thereof;
ii) generate at least one second computer instruction related to at least one delivery of the at least one item to the second user, wherein the at least one delivery is set by the first user, and wherein the at least one second computer instruction is at least one of:
(i) designating a delivery address for the at least one delivery of the at least one item, wherein the delivery address is a physical location of the cabinet,
(ii) obtaining a status of the at least one cell of the plurality of cells,
(iii) instructing the locker controller to open or close the at least one cell,
(iv) generating delivery information regarding the at least one delivery, wherein the delivery information comprising the delivery address and an identification for the at least one cell within the cabinet, and
(v) any combination thereof.

2. The cabinet of claim 1, wherein the cabinet comprises between 1-20 locker cases.

3. The cabinet of claim 1, wherein the plurality of cells is between 10-50 cells.

4. The cabinet of claim 1, wherein the management module is further configured to electronically interact with a graphical user interface which is programmed to allow the first user to set the at least one delivery.

5. The cabinet of claim 4, wherein the graphical user interface is associated with the cabinet.

6. The cabinet of claim 4, wherein the graphical user interface is associated with a mobile device of the first user.

7. The cabinet of claim 1, wherein the graphical user interface is configured to permit the at least one first user to remotely access the cabinet.

8. The cabinet of claim 1, wherein the management module is further configured to accept a payment for the at least one item from the second user prior to instructing the locker controller to open the at least one cell opening to deliver the at least one item to the second user.

9. The cabinet of claim 1, wherein the management module is further configured to accept a payment from the first user for delivering the at least one item.

10. The cabinet of claim 1, wherein the electronic notification related to the first user can further include information regarding a time of the at least one delivery, a price of the at least one item, the availability of the at least one item, or any combination thereof.

11. The cabinet of claim 1, wherein the at least one second computer instruction for instructing the locker controller to open or close the at least one cell is transmitted utilizing binary code.

12. A method, comprising:
verifying, by a specifically programmed computer processor, a first user based on
at least one security measure related to the first user, comprising:
1) a password input,
2) a fingerprint input,
3) an optical input of at least one physical characteristic of the first user,
4) an electronic notification related to the first user,
5) or any combination thereof;
receiving, by the specifically programmed computer processor, a first part of delivery information of at least one item from the first user, comprising at least a plurality of:
1) a description of the at least one item,
2) a delivery address for at least one delivery of the at least one item, wherein the delivery address is a physical location of a cabinet,
3) a delivery time for the at least one delivery of the at least one item,
4) at least one cost associated with the at least one item, and
5) any combination thereof;
wherein the cabinet comprises:
at least one dispensing unit which comprises at least one locker case, wherein the
at least one locker case comprises a plurality of cells,
wherein each cell of the plurality of cells is configured to:
(i) receive the at least one item from a first user,
(ii) store the at least one item, and
(iii) deliver the at least one item to a second user;
a locker controller configured to control a plurality of operations performed by the cabinet, comprising:
(i) send at least one first computer instruction to the at least one locker case, and
(ii) receive at least one first electronic response in reply to the at least one first computer instruction from the at least one locker case, and
wherein the at least one first computer instruction is configured to open or close at least one cell of the plurality of cells;
allowing, by the specifically programmed computer processor, the first user to deposit the at least one item in at least one cell of a plurality of cells in the cabinet,
generating, by the specifically programmed computer processor, a second part of delivery information related to the at least one item to the first user, wherein the second part of delivery information comprising:
1) a time when the at least one item has been delivered to a second user,
2) a payment of the at least one item by the second user,
3) a completed delivery of the at least one item to the second user, and
4) any combination thereof.

13. The method of claim 12, wherein the delivery information is transmitted to the second user.

14. The method of claim 12, wherein the second user can pay for the at least one item at the time of the at least one delivery.

15. The method of claim 12, wherein the first user can pay for the at least one item prior to the at least one delivery.

16. The method of claim 12, wherein the cabinet comprises between 1-20 locker cases.

17. The method of claim 12, wherein the plurality of cells is between 10-50 cells.

18. The method of claim 12, wherein the electronic notification related to the first user can further include information regarding a time of the at least one delivery, a price of the at least one item, the availability of the at least one item, or any combination thereof.
